(19) United States
(12) Patent Application Publication
(10) Pub. No.: US 2025/0362202 A1
(43) Pub. Date: Nov. 27, 2025

(54) INSPECTION FIXTURES, INSPECTION SYSTEMS, INSPECTION METHODS, AND COMPUTER PROGRAM PRODUCTS FOR INSPECTING WORKPIECES USING INSPECTION FIXTURES AND INSPECTION SYSTEMS

(71) Applicant: ASM IP Holding B.V., Almere (NL)

(72) Inventors: Christopher Falcone, Chandler, AZ (US); Ryan Piazzo, Queen Creek, AZ (US); Shreyas Parameshwaran, Laveen Village, AZ (US); Dinkar Nandwana, Chandler, AZ (US); Sheshraj Tulshibagwale, Chandler, AZ (US); Iordan Iordanov, Tempe, AZ (US); Osama Khalil, Phoenix, AZ (US); Alex Ryan Rabinovich, Redlands, CA (US)

(21) Appl. No.: 19/212,029

(22) Filed: May 19, 2025

Related U.S. Application Data
(60) Provisional application No. 63/650,738, filed on May 22, 2024.

(51) Int. Cl. G01M 13/00

(52) U.S. Cl. CPC G01M 13/00

(57) ABSTRACT

An inspection fixture includes a seat to support a workpiece, a backpressure sensor and a focal plane array. The backpressure sensor is coupled to seat to acquire backpressure of a fluid traversing one of a first flow aperture and a second flow aperture defined in the workpiece supported on the seat of the inspection fixture. The optical focal plane array is also coupled to the seat to acquire optical image data of a portion of the workpiece including one or more of the first flow aperture and the second flow aperture defined in the workpiece supported on the seat of the inspection fixture. Inspection systems, inspection methods, and computer program products for inspecting workpieces are also described.

### CROSS-REFERENCE TO RELATED APPLICATIONS

This application claims priority to and the benefits of U.S. Provisional Patent Application No. 63/650,738, filed May 22, 2024, the contents of which are incorporated herein by reference in its entirety.

### FIELD OF INVENTION

The present disclosure generally relates to fluid systems, and more particularly to inspecting workpieces employed to control fluid flow in fluid systems.

### BACKGROUND OF THE DISCLOSURE

Fluid systems commonly employ flow control devices to control fluid flow within the fluid system. The flow control devices generally have flow passages sized and dimensioned to control flow properties of fluid traversing the fluid system. Fabrication of such flow control devices is typically controlled to ensure that flow passage size and dimensions correspond to desired sizing and dimensioning. In some fluid systems, flow control devices may be periodically removed and cleaned to ensure that the flow passages within the flow control device retain the desired sizing and dimensioning imparted during manufacture of the flow control.

In some fabrication and/or cleaning processes sizing and dimensioning of flow passages may be inspected, for example to ensure that chips and cuttings formed during the fabrication process are not left in flow passages within the flow control device and/or verify efficacy of the cleaning process used to clean the workpiece. Inspection generally adds cost to the fabrication or cleaning process, typically commensurate with the time required for the inspection.

Such systems and methods have generally been satisfactory for their intended purpose. However, therein remains a need for improved inspection fixtures, inspection systems, and inspection methods and related computer program products for inspecting workpieces. The present disclosure provide a solution to this need.

### SUMMARY OF THE DISCLOSURE

An inspection fixture is provided. The inspection fixture includes a seat to support a workpiece, a backpressure sensor and a focal plane array. The backpressure sensor is coupled to seat to acquire backpressure of a fluid traversing one of a first flow aperture and a second flow aperture defined in the workpiece supported on the seat of the inspection fixture. The optical focal plane array is also coupled to the seat to acquire optical image data of a portion of the workpiece including one or more of the first flow aperture and the second flow aperture defined in the workpiece supported on the seat of the inspection fixture.

In addition to one or more of the features described above, or as an alternative, further examples of the inspection fixture may include a fluid conduit with an outlet supported for movement relative to the seat. The backpressure sensor may be arranged along the fluid conduit.

In addition to one or more of the features described above, or as an alternative, further examples of the inspection fixture may include a fluid source connected to the fluid conduit and therethrough to the backpressure sensor. The fluid source may be configured to communicate the fluid to one or more of the first flow aperture and the second flow aperture through the backpressure sensor using the fluid conduit.

In addition to one or more of the features described above, or as an alternative, further examples of the inspection fixture may include a light source and a calibration block. The light source may be fixed relative to the seat. The calibration block may be fixed relative to the seat and offset from the light source. The calibration block may define one or more calibration flow aperture therethrough.

In addition to one or more of the features described above, or as an alternative, further examples of the inspection fixture may include one or more optical element supported for movement relative to the seat. The one or more optical element may be optically coupled to the optical focal plane array along an optical axis.

In addition to one or more of the features described above, or as an alternative, further examples of the inspection fixture may include that the one or more optical element comprises one or more of a lens, a mirror, and a grating.

In addition to one or more of the features described above, or as an alternative, further examples of the inspection fixture may include a fluid conduit with an outlet supported for movement relative to the seat. The outlet of the fluid conduit may be is fixed relative to the one or more optical element.

In addition to one or more of the features described above, or as an alternative, further examples of the inspection fixture may include a workpiece supported on the seat of the inspection fixture. The workpiece may have a first surface separated from a second surface by a thickness. The first surface of the workpiece may be coupled to the second surface by the first flow aperture. The first surface of the workpiece may further be coupled to the second surface by the second flow aperture.

In addition to one or more of the features described above, or as an alternative, further examples of the inspection fixture may include that the first flow aperture is one of a plurality of first flow apertures having a first width, that the second flow aperture is one of a plurality of second flow apertures having a second width, and that the second width of the plurality of second flow apertures is greater than the first width of the plurality of first flow apertures.

In addition to one or more of the features described above, or as an alternative, further examples of the inspection fixture may include that one or more of a chip, a cutting, or an accretion from a process fluid communicated by the workpiece through the first flow aperture and/or the second flow aperture occludes one or more of the first flow aperture and the second flow aperture defined in the workpiece.

In addition to one or more of the features described above, or as an alternative, further examples of the inspection fixture may include that the workpiece comprises a showerhead configured to distribute a process fluid within a process volume defined in a semiconductor processing system.

In addition to one or more of the features described above, or as an alternative, further examples of the inspection fixture may include a crossbeam, a probe member, and one or more optical element. The crossbeam may be supported for movement relative to the seat of the inspection fixture. The probe member may be carried by the crossbeam and supported for movement relative to the crossbeam of the inspection fixture. The fluid conduit may have an outlet fixed relative to the probe member of the inspection fixture and the one or more optical element may be fixed relative to the probe member of the inspection fixture.

An inspection system is provided. The inspection system includes an inspection fixture as described above, a processor and a memory. The recited processor is disposed in communication with the backpressure sensor and the optical focal plane array. The memory includes a non-transitory machine-readable medium having instructions recorded in a plurality of program modules that, when read by the processor, cause the processor to receive backpressure of a fluid traversing one of a first flow aperture and a second flow aperture defined in the workpiece supported on the seat from the backpressure sensor; determine fluid conductance of one or more of the first flow aperture and the second flow aperture using the backpressure received from the backpressure sensor; receive optical image data of a portion of the workpiece including one or more of the first flow aperture and the second flow aperture defined in the workpiece supported on the seat from the optical focal plane array; and determine flow area of one or more of the first flow aperture and the second flow aperture using the optical image data received from the optical focal plane array.

An inspection method is provided. The inspection method includes registering an outlet of a fluid conduit in fluid communication with the backpressure sensor to one of the first flow aperture and the second flow aperture defined in the workpiece seated on the seat of the inspection fixture; abutting the outlet of the fluid conduit sealably about the one of the first flow aperture and the second flow aperture; flowing a fluid through from a fluid source through the backpressure sensor and the fluid conduit to the one of the first flow aperture and the second flow aperture; acquiring backpressure of the fluid from the backpressure sensor as the fluid traverses the workpiece through the one of the first flow aperture and the second flow aperture; comparing the backpressure acquired by the backpressure sensor to a predetermined backpressure value; and inspecting flow area of one of the first flow aperture and the second flow aperture when the acquired backpressure differs from the predetermined backpressure value by more than a predetermined backpressure differential.

In addition to one or more of the features described above, or as an alternative, further examples of the inspection method may include registering an outlet of a fluid conduit in fluid communication with the backpressure sensor to one of the first flow aperture and the second flow aperture defined in the workpiece seated on the seat of the inspection fixture; abutting the outlet of the fluid conduit sealably about the one of the first flow aperture and the second flow aperture; flowing a fluid through from a fluid source through the backpressure sensor and the fluid conduit to the one of the first flow aperture and the second flow aperture; acquiring backpressure of the fluid from the backpressure sensor as the fluid traverses the workpiece through the one of the first flow aperture and the second flow aperture; comparing the backpressure acquired by the backpressure sensor to a predetermined backpressure value; and inspecting flow area of one of the first flow aperture and the second flow aperture when the acquired backpressure differs from the predetermined backpressure value by more than a predetermined backpressure differential.

In addition to one or more of the features described above, or as an alternative, further examples of the inspection method may include registering an optical element arranged along an optical axis with one of the first flow aperture and the second flow aperture seated on the seat of the inspection fixture; translating the optical element along the optical axis relative to the one of the first flow aperture and the second flow aperture to optically couple the optical focal plane array; acquiring optical image data of the workpiece including the one of the first flow aperture and the second flow aperture using the optical focal plane array; determining flow area of the one of the first flow aperture and the second flow aperture using the acquired optical image data; comparing the determined flow area of the one of the first flow aperture and the second flow aperture to a predetermined flow area value; and removing the workpiece from the seat for rework when the determined flow area of the one of the first flow aperture and the second flow aperture differs from a predetermined flow area value by more than a predetermined flow area differential.

In addition to one or more of the features described above, or as an alternative, further examples of the inspection method may include that acquiring backpressure comprises acquiring backpressure of only the first flow aperture defined in the workpiece. No backpressure may be acquired from the second flow aperture defined in the workpiece.

In addition to one or more of the features described above, or as an alternative, further examples of the inspection method may include that acquiring optical image data comprises acquiring optical image data of both the first flow aperture and the second flow aperture.

In addition to one or more of the features described above, or as an alternative, further examples of the inspection method may include acquiring radiographic image data of the workpiece, wherein the backpressure and the optical image data are acquired using the radiographic image data of the workpiece.

In addition to one or more of the features described above, or as an alternative, further examples of the inspection method may include calibrating the backpressure sensor prior to inspecting backpressure and subsequent to inspecting backpressure of the workpiece.

A computer program product is provided. The computer program product includes a non-transitory machine readable medium having instructions recorded on the medium that, when read by a processor, cause the processing to receive backpressure of a fluid traversing one of a first flow aperture and a second flow aperture defined in a workpiece supported at a seat of an inspection fixture using a backpressure sensor coupled to the seat of the inspection fixture; determine fluid conductance of one or more of the first flow aperture and the second flow aperture using the backpressure received from the backpressure sensor; receive optical image data of a portion of the workpiece including one or more of the first flow aperture and the second flow aperture defined in the workpiece from an optical focal plane array coupled to the seat of the inspection fixture; and determine flow area of one or more of the first flow aperture and the second flow aperture using the optical image data received from the optical focal plane array.

This summary is provided to introduce a selection of concepts in a simplified form. These concepts are described in further detail in the detailed description of examples of the disclosure below. This summary is not intended to identify key features or essential features of the claimed subject matter, nor is it intended to be used to limit the scope of the claimed subject matter.

### BRIEF DESCRIPTION OF THE DRAWING FIGURES

These and other features, aspects, and advantages of the invention disclosed herein are described below with reference to the drawings of certain embodiments, which are intended to illustrate and not to limit the invention.

FIG. 1 is a schematic view of a fluid system including a workpiece inspected using an inspection fixture according to the present disclosure, showing the workpiece being installed in the fluid system after being inspected using the inspection fixture;

FIGS. 2 and 3 are plan and cross-sectional side views of the workpiece of FIG. 1 according to an example to the present disclosure, showing a plurality of first flow and second flow apertures having first and second widths defined in a showerhead workpiece;

FIG. 4 is a schematic view of an inspection system including the inspection fixture of FIG. 1 according to an example of the present disclosure, showing a backpressure sensor and optical focal plane array coupled to a seat of the inspection fixture;

FIGS. 5 and 6 are schematic views of the inspection fixture of FIG. 1 according to an example of the present disclosure, showing fluid conductance and flow area of a flow aperture defined in the workpiece being inspected for fluid conductance and flow area, respectively; and

FIGS. 7-10 are a block diagram of an inspection method in accordance with the present disclosure, showing operations of the method according to an illustrative and non-limiting example of the present disclosure.

It will be appreciated that elements in the figures are illustrated for simplicity and clarity and have not necessarily been drawn to scale. For example, the relative size of some of the elements in the figures may be exaggerated relative to other elements to help improve understanding of illustrated embodiments of the present disclosure.

### DETAILED DESCRIPTION OF EXEMPLARY EMBODIMENTS

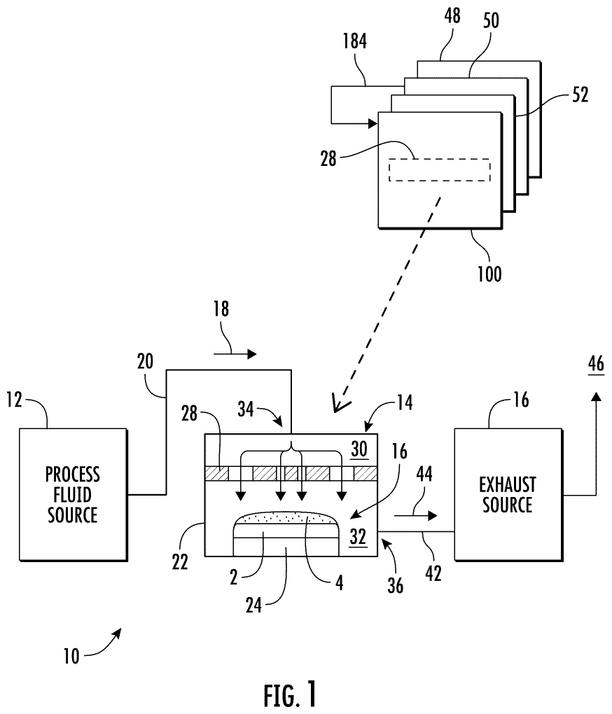

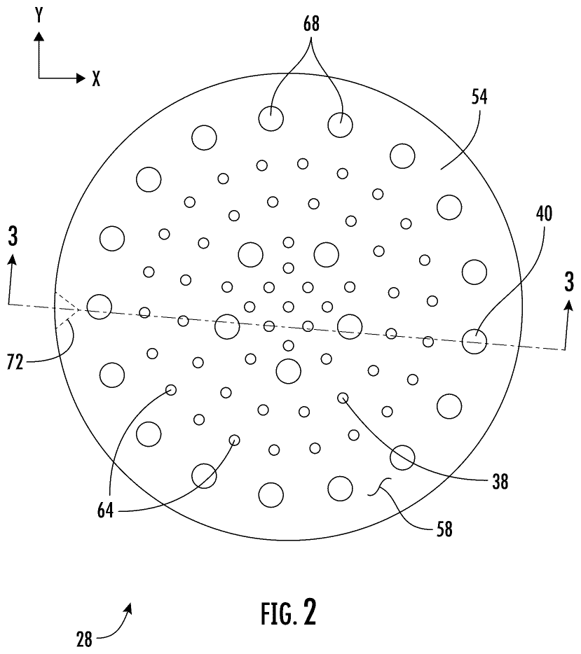

Reference will now be made to the drawings wherein like reference numerals identify similar structural features or aspects of the subject disclosure. For purposes of explanation and illustration, and not limitation, a partial view of an example of an inspection fixture in accordance with the present disclosure is shown in FIG. 1 and is designated generally by reference character 100. Other examples of inspection fixtures, inspection systems including inspection fixtures and inspection methods and related computer program products for inspecting workpieces in accordance with the present disclosure, or aspects thereof, are provided in FIGS. 2-10, as will be described. The systems and methods of the present disclosure may be used to inspect workpieces having flow apertures defined therein for controlling fluid flow in fluid systems, such as showerhead employed in semiconductor processing systems to deposit material layers onto substrates and/or remove material from substrates, through the present disclosure is not limited to semiconductor processing systems or any particular type of fluid system in general.

Referring to FIG. 1, a fluid system 10 according to an example of the present disclosure is shown. In the illustrated example the fluid system 10 includes a semiconductor processing system configured to deposit a material layer 4 onto a substrate 2 and/or remove material from the substrate 2 and in this respect includes a process fluid source 12, a chamber arrangement 14, and exhaust source 16. The process fluid source 12 is configured to provide a process fluid 18 to the chamber arrangement 14 and in this respect is connected to the chamber arrangement 14 by a process fluid supply conduit 20. The chamber arrangement 14 incudes a chamber body 22, a substrate support 24 arranged within an interior 26 of the chamber body 22, and a workpiece 28 (e.g., a showerhead) seated within the interior 26 of the chamber body 22 and dividing the interior 26 of the chamber body 22 into a distribution plenum 30 and a process volume 32. It is contemplated that the substrate support 24 be arranged within the process volume 32 and configured to seat thereon the substrate 2 during deposition of the material layer 4 onto the substrate 2 and/or removal of material from the substrate 2. It is also contemplated that the chamber body 22 define an inlet port 34 and an exhaust port 36, the workpiece 28 fluidly couple the inlet port 34 to the exhaust port 36 via the distribution plenum 30 and the process volume 32 through one or more first flow aperture 38 (shown in FIG. 2) and one or more second flow aperture 40 (shown in FIG. 2), and that the exhaust source 16 be connected to the exhaust port 36 by an exhaust conduit 42 to communicate residual process fluid and/or reaction products 44 to an external environment 46 outside of the fluid system 10. In certain examples, the fluid system 10 may be configured as a material layer deposition apparatus to deposit the material layer 4 onto the substrate 2 using an atomic layer deposition (ALD) technique or a plasma-enhanced ALD technique. In accordance with certain example, the fluid system 10 may be configured to deposit the material layer 4 onto the substrate 2 using a chemical vapor deposition (CVD) or a plasma-enhanced CVD technique. It is also contemplated that the fluid system 10 may be configured as an etch apparatus, for example to remove material from the substrate 2 using a dry etch technique and remain within the scope of the present disclosure. Although shown and described herein as a semiconductor processing system, it is to be understood and appreciated that other types of fluid systems may also benefit from the present disclosure.

As used herein the term “substrate” may refer to any underlying material or materials, including any underlying material or materials that may be modified, or upon which, a device, a circuit, or a film may be formed. A substrate may be continuous or non-continuous; rigid or flexible; solid or porous; and combinations thereof. A substrate may be in any form such as (but not limited to) a powder, a plate, or a workpiece. A substrate in the form of a plate may include a wafer in various shapes and sizes, for example, including 300-millimeter wafers. A substrate may be formed from semiconductor materials, including, for example, silicon (Si), silicon-germanium (SiGe), silicon oxide (SiO₂), gallium arsenide (GaAs), gallium nitride (GaN) and silicon carbide (SiC). A substrate may include a pattern or may be unpatterned, such as a so-called blanket-type substrate. As examples, substrates in the form of a powder may have applications for pharmaceutical manufacturing. A porous substrate may include one or more polymers. Examples of workpieces may include medical devices (for example, stents and syringes), jewelry, tooling devices, components for battery manufacturing (for example, anodes, cathodes, or separators) or components of photovoltaic cells, etc. A continuous substrate may extend beyond the bounds of a process chamber where a deposition process occurs. In some processes, a continuous substrate may move through the process chamber such that the process continues until the end of the substrate is reached. A continuous substrate may be supplied from a continuous substrate feeding system to allow for manufacture and output of the continuous substrate in any appropriate form. Non-limiting examples of continuous substrates may include sheets, non-woven films, rolls, foils, webs, flexible materials, bundles of continuous filaments or fibers (for example, ceramic fibers or polymer fibers). A continuous substrate may also comprise a carrier or sheet upon which one or more non-continuous substrate is mounted.

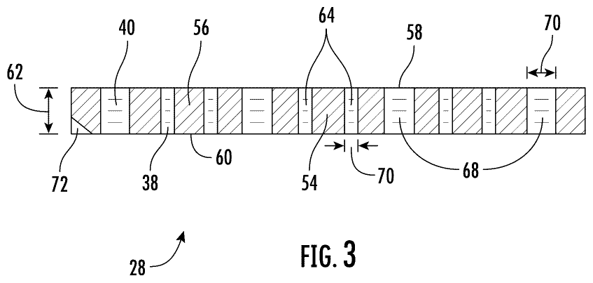

As will be appreciated by those of skill in the art in view of the present disclosure, workpieces may be fabricated flow apertures sized and dimensioned to control fluid flow within a fluid system according to the requirements of the fluid system. For example, the one or more first flow aperture 38 (shown in FIG. 3) and the one or more second flow aperture 40 (shown in FIG. 3) may be sized and dimensioned to distribute the process fluid 18 within the process volume to 34 to impart desired properties into the material layer 4 and/or the substrate 2, for example material layer thickness uniformity and/or compositional uniformity. As will also be appreciated by those of skill in the art in view of the present disclosure, blockage (partial or complete) of flow apertures defined within workpieces can, in some fluid systems, alter flow through the workpiece, potentially changing fluid flow within the fluid system. For example, chips or cuttings 6 (shown in FIG. 3) formed during fabrication of the workpiece 28 occluding the one or more first flow aperture 38 and/or the one or more second flow aperture 40, may influence properties of the material layer 4 and/or the substrate 2 in the event that the workpiece 28 is installed within chamber body 22 without rework of the workpiece 28 to remove the chips or cuttings 6. Process fluid accretions 8 (shown in FIG. 3) occluding the one or more first flow aperture 38 and the one or more second flow aperture 40, such as due to incomplete cleaning of the workpiece 28, may also influence properties of the material layer 4 and/or the substrate 2 in the event that the workpiece 28 is installed in the chamber body 22 without rework (e.g., recleaning) the workpiece 28. To identify such occlusions in the one or more first flow aperture 38 and the one or more second flow aperture 40, the inspection fixture 100 is provided for inspecting the workpiece 28 following one or more of fabrication (or fabrication rework) 48 of the workpiece 28, radiographic inspection 50 of the workpiece 28, and/or cleaning (or recleaning) 52 of the workpiece 28.

With reference to FIGS. 2 and 3, the workpiece 28 is shown according to an example of the present disclosure. As shown in FIG. 2, in the illustrated example the workpiece 28 includes a workpiece body 54 formed from a metallic material 56 (shown in FIG. 3). It is contemplated that the workpiece body 54 have a first surface 58 and an opposite second surface 60 separated from one another by thickness 62 of the workpiece body 54. It is also contemplated that the one or more first flow aperture 38 couple (e.g., fluidly) the first surface 58 to the second surface 60 of the workpiece body 54, that the one or more second flow aperture 40 also couple (e.g. fluidly) the first surface 58 to the second surface 60 of the workpiece body 54, and that the workpiece body 54 may be generally circular in shape.

In certain examples of the present disclosure the one or more first flow aperture 38 may be one of a plurality of first flow apertures 64 defined in the workpiece body 54. In such examples the plurality of first flow apertures 64 may each having a first width 66, which may be a first diameter wherein the plurality of first flow apertures 64 define generally circular flow areas within the workpiece 28. In accordance with certain examples, the one or more second flow aperture 40 may be one of a plurality of second flow apertures 68 defined in the workpiece body 54. The plurality of second flow apertures 68 may each have a second width 70, which may be greater than the first width 66 defined by the plurality of first flow apertures 64, and which also be generally circular in shape. It is contemplated that the workpiece body 54 may be configured and adapted fixation within a semiconductor processing system. In this respect the workpiece body 54 may define a chamber fixation feature 72, for example on or within the second surface 60 of the workpiece body 54. The chamber fixation feature 72 may be configured to constrain position of the workpiece 28 in cooperation with a conjugate chamber body fixation feature defined within the interior 26 (shown in FIG. 1) chamber body 22 (shown in FIG. 1), such as to require one-way orientation of the workpiece 28 when seated in the chamber body 22 to error-proof installation of the workpiece 28 in the fluid system 10 (shown in FIG. 1).

The metallic material 56 forming the workpiece body 54 may comprise (or consist of or consist essentially of) an aluminum-containing material, a stainless steel material, or a nickel-containing material. Examples of suitable aluminum-containing materials include aluminum alloys, such as 6061 aluminum alloy; examples of suitable stainless steel materials include 316 stainless; and examples of suitable nickel-containing materials include Hastelloy as well as bulk nickel. As will be appreciated by those of skill in the art in view of the present disclosure, forming the workpiece body 54 from an aluminum-containing material can limit time required to form the workpiece body 54, for example be enabling relatively high material removal rates during fabrication 48 (shown in FIG. 1) of the workpiece 28. As will also be appreciated by those of skill in the art in view of the present disclosure, forming the workpiece body from a stainless steel material and/or a nickel-containing material can simplify the refurbishing the workpiece 28 subsequent to use, for example by increasing the alternative chemistries that may be employed during the cleaning 52 (shown in FIG. 1) of the workpiece 28.

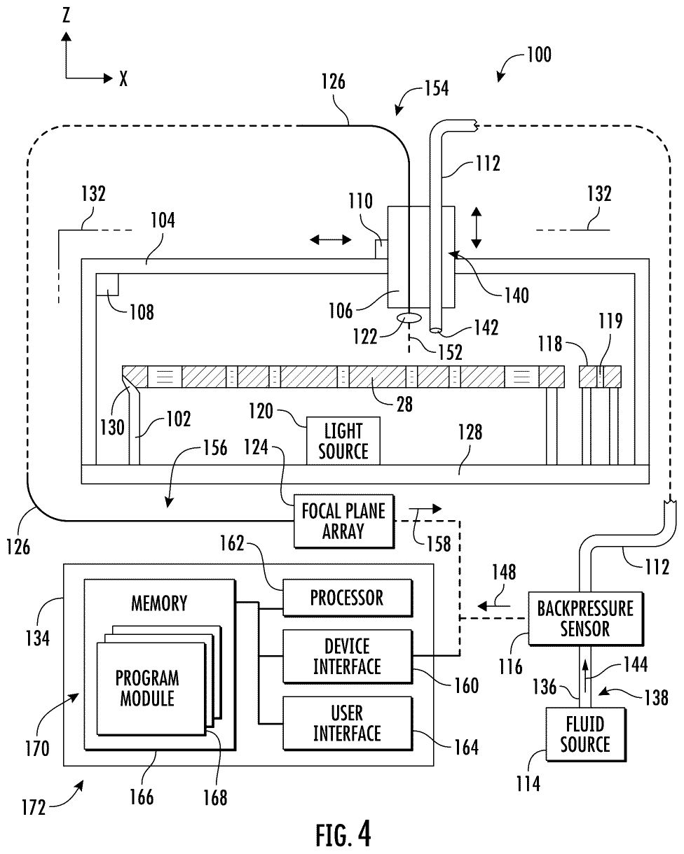

With reference to FIG. 4, the inspection fixture 100 is shown according to an example of the present disclosure. In the illustrated example the inspection fixture 100 includes a seat 102, a crossbeam 104, a probe member 106, a registration drive 108, and an abutment/focus drive 110. As shown and described herein the inspection fixture 100 also includes a fluid conduit 112, a fluid source 114, a backpressure sensor 116, a calibration block 118, a light source 120, an optical element 122, an optical focal plane array 124, and an optical waveguide 126. Although shown and described herein as having certain elements and a specific arrangement, it is to be understood and appreciated that the inspection fixture 100 may include other elements and/or omit elements shown and described herein, as well as have a different arrangement in other examples and remain within the scope of the present disclosure.

The seat 102 is fixed to a base 128 and is configured and adapted to support the workpiece 28. In this respect the seat 102 may be correspond geometrically and dimensionally to a showerhead seat defined within the chamber body 22 (shown in FIG. 1). In further respect, the seat 102 may additionally define thereon a showerhead fixation feature 130 corresponding to a showerhead fixation feature defined within the chamber body 22, for example a fastener pattern and key, defined at the showerhead seat within the chamber body 22. In such examples the showerhead fixation feature 130 may correspond and/or be conjugate to the chamber fixation feature 72 (shown in FIG. 2). As will be appreciated by those of skill in the art in view of the present disclosure, this can simplify use of the inspection fixture 100, for example by error proofing orientation and position of the workpiece 28 on the seat 102. In certain examples of the present disclosure the seat 102 may be further arranged within an enclosure 132. The enclosure 132 may in turn separate movable elements of the inspection fixture 100 from the environment external to the inspection fixture 100, limiting (or eliminating) risk that such elements could potentially present to users in the vicinity of the inspection fixture 100.

The crossbeam 104 is supported for movement relative to the seat 102 and carries the probe member 106. In this respect it is contemplated that the crossbeam 104 may span the seat 102 and the workpiece 28 when seated thereon. In further respect, the crossbeam 104 may be supported for movement in an x-y plane substantially parallel to the seat 102 and the first surface 58 of the workpiece 28 when supported on the seat 102. Movement of the crossbeam 104 may be via the registration drive 108 (e.g., a stepper motor, linear motor, or lead screw arrangement), which may be operably connected to the crossbeam 104 to drive the crossbeam 104 relative to the seat 102 in the x-y plane, and which in turn may operably couple a controller 134 to the crossbeam 104 configured to drive the crossbeam 104 via the registration drive 108. Examples suitable crossbeams and registration drives include MXYx gantries and drive assemblies, available from YRG Inc. of Fort Wayne, Indiana.

The probe member 106 carries a portion of the fluid conduit 112 and the one or more optical element 122, travels with crossbeam 104, and may be supported above the seat 102 by the crossbeam 104. In certain examples of the present disclosure the probe member 106 may be supported for movement relative to the crossbeam 104. In this respect the probe member 106 may be supported for movement along an axis orthogonal relative the x-y plane within which the crossbeam 104 moves, for example along a z-axis. Movement of the probe member 106 may be via the abutment/focus drive 110 (e.g., a stepper motor, linear motor, or lead screw arrangement), which may be operably connected to the probe member 106 to drive the probe member 106 relative to seat 102 along the z-axis, and which in turn itself operably couple the controller 134 to the probe member 106. In accordance with certain examples, the probe member 106 may be fixed relative to the crossbeam 104, and the portion of the fluid conduit 112 carried by the probe member 106 and/or the one or more optical element 122 may be movable relative to the probe member 106. As will be appreciated by those of skill in the art in view of the present disclosure, supporting the probe member 106 for movement relative to the crossbeam 104 may simplify arrangement of the inspection fixture 100, for example by limiting the number a position teaches and maintenance of position teaches once established.

The fluid conduit 112 has an inlet end 136 with an inlet 138 and a fluidly opposite outlet end 140 with an outlet 142. It is contemplated that the outlet end 140 and the outlet 142 of the fluid conduit 112 be supported for movement relative to the seat 102 and in this respect may be carried by the probe member 106 and the crossbeam 104. It is also contemplated that the inlet end 136 and the inlet 138 be fixed relative to the seat 102 and fluidly couple the fluid source 114 to the outlet 142 of the fluid conduit 112. It is further contemplated that the fluid source 114 be configured to communicate a fluid 144 to the outlet 142 through the fluid conduit 112, and in this respect the backpressure sensor 116 may be arranged along the fluid conduit 112 and fluidly couple the fluid source 114 to the outlet 142 of the fluid conduit 112. In certain examples the outlet end 140 of the fluid conduit 112 may be supported such that both the seat 102 and the calibration block 118 are within a movement envelope of the outlet end 140 and outlet 142 of the fluid conduit 112. As will be appreciated by those of skill in the art in view of the present disclosure, this enable in-situ and on-the-fly calibration of the backpressure sensor 116 and the crossbeam 104, simplifying maintenance of the inspection fixture 100 and improving reliability of flow conductance measurements acquired using the inspection fixture 100.

In certain examples of the present disclosure, the fluid 144 may comprise (or consist of or consist essentially of) air. In accordance with certain examples of the present disclosure, the fluid 144 may comprise (or consist of or consist essentially of) an inert gas. Examples of suitable inert gases include nitrogen (N₂) gas as well as noble gases such as argon (Ar) gas, helium (He) gas, krypton (Kr) gas and inert gas mixtures including one or more of the aforementioned gases. As will be appreciated by those of skill in the art in view of the present disclosure, employment inert gases may limit (or eliminate) risk that the fluid 144 contaminate the workpiece 28 during fluid conductance inspection. As will also be appreciated by those of the skill in the art in view of the present disclosure, employment of air for fluid conductance inspection may simplify arrangement of the inspection fixture 100, for example by limiting (or eliminating) the need to employ countermeasures for the suffocation hazard potentially posed by the employment of inert gases for fluid conductance inspection.

The backpressure sensor 116 is coupled to the seat 102 of the inspection fixture 100 and is configured to acquire backpressure of the fluid 144 from within the fluid conduit 112 as the fluid 144 traverses one or more of the first flow aperture 38 and the one or more second flow aperture 40 defined in the workpiece 28. In this respect the backpressure sensor 116 is arranged along the fluid conduit 112 and may be fixed relative to the seat 102. In further respect, the backpressure sensor 116 may be disposed in communication with the controller 134, for example by a wired or wireless link 146, and configured to provide the controller 134 a backpressure signal 148 indicative of backpressure of the fluid 144 within the fluid conduit 112. Although shown and described as being fixed relative to the seat 102 while the outlet end 140 of the fluid conduit 112 is carried by the probe member 106, it is to be understood and appreciated that the backpressure sensor 116 may be carried by the probe member 106 in other examples and remain within the scope of the present disclosure. Examples of suitable backpressure sensors include Millimar® series backpressure measuring sensors, available from Mahr GmbH of Göttingen, Germany.

The calibration block 118 is fixed relative to the seat 102 and defines one or more calibration flow aperture 119 therethrough. It is contemplated that the calibration block 118 supported on the inspection fixture 100 at a location proximate the seat 102, for example at a location outside of a periphery of the 28 when the workpiece is supported at the seat 102. It is further contemplated that the one or more calibration flow aperture 119 extend through the calibration block 118 and sized in dimensioned such that, when the outlet 142 of the fluid conduit 112 abuts an upper surface of the calibration block 118, the calibration fluid 144 traverses the one or more calibration flow aperture 119 and issues from a lower surface of the calibration block 118 such that backpressure measurements acquired from the backpressure sensor 116 may be used to assess accuracy and/or health of the backpressure sensor 116. In certain examples of the present disclosure the one or more calibration flow aperture 119 may have an effective flow area substantially equivalent to a desired flow area of one of the first flow aperture 38 and the second flow aperture 40. In accordance with certain examples, the one or more calibration flow aperture 119 may be one of a plurality of different sized calibration flow apertures bracketing effective flow area of the one of the first flow aperture 38 and the second flow aperture 40. As will be appreciated by those of skill in the art in view of the present disclosure, fixing the calibration block 118 relative to the seat on the inspection fixture 100 enables the in-situ and/or on-the-fly calibration of the backpressure flow sensor 116.

The light source 120 is configured to illuminate an underside of the workpiece 28 when the workpiece 28 is supported on the seat 102. In this respect it is contemplated that the light source 120 be fixed relative to the seat 102. In further respect, the light source 120 may be arranged within a footprint of seat 102 such the workpiece 28 is between the light source 120 and the probe member 106 when the fluid conductance inspection and/or optical inspection of the workpiece 28 is being performed. It is also contemplated that the light source 120 be offset from the calibration block 118 relative to the seat 102, and the calibration block 118 similarly be offset from the light source 120 relative to the seat 102, and that the light source 120 be configured to generate illumination within a visible waveband. Advantageously, illuminating the underside of the workpiece 28 may improve accuracy of the optical flow area measurement acquired using the one or more optical element 122, for example by increasing resolution and/or contrast between the bulk material forming the workpiece the one of the first flow aperture 38 and the second flow aperture 40 acquired using the inspection fixture 100.

The one or more optical element 122 is supported for movement relative to the seat 102 of the inspection fixture 100. The one or more optical element 122 may further be optically coupled to the optical focal plane array 124 along an optical axis 152. It is contemplated that the one or more optical element 122 may be fixed relative to the outlet 142 of the fluid conduit 112. It is also contemplated that the one or more optical element 122 be optically coupled to the optical focal plane array 124 by the optical waveguide 126 and in this respect the optical waveguide 126 may have an input end 154 and an output end 156. The input end 154 of the optical waveguide 126 may be supported by the probe member 106 (e.g., carried thereby), and proximate the one or more optical element 122. The output end 156 of the optical waveguide 126 may in turn be fixed relative to the seat 102 and proximate the optical focal plane array 124, the optical axis 152 extending through the optical waveguide 126 such that light collected by the one or more optical element 122 is conveyed to the optical focal plane array 124.

The optical focal plane array 124 is configured to generate optical image data 158 using light incident upon the optical focal plane array 124 through the optical waveguide 126 and may be fixed relative to the seat 102 of the inspection fixture 100. The optical focal plane array 124 may further be configured to provide the optical image data 158 to the controller 134, for example optical image data including a portion of the workpiece 28 including either of the one or more first flow aperture 38 and the one or more second flow aperture 40, and in this respect may be connected to the optical focal plane array 124 by the wired or wireless link 146. In certain examples the one or more optical element 122 may comprise a lens, a mirror, and/or a grating. In accordance with certain examples, the optical waveguide 126 may comprise an optical fiber. Although shown and described herein as remote from the one or more optical element 122, it is to be understood and appreciated that the optical focal plane array 124 may be co-located with the one or more optical element 122, for example similarly carried by the probe member 106 as a singular imaging sensor, and remain within the scope of the present disclosure. Examples of suitable optical focal plane arrays include those included in In-Sight vision systems, available from Cognex Corporation of Natick, Massachusetts.

The controller 134 includes a device interface 160, a processor 162, a user interface 164, and a memory 166. The device interface 160 connects to the processor 162 to the inspection fixture 100 through the wired or wireless link 146. In this respect it is contemplated that the device interface 160 communicatively couple the processor 162 to one or more of the registration drive 108, the abutment/focus drive 110, the backpressure sensor 116, the light source 120, and/or the optical focal plane array 124. The processor 162 is in turn operatively connected to the user interface 164, for example to receive a user input therefrom and/or to provide a user output thereto, and is disposed in communication with the memory 166. The memory 166 includes a non-transitory machine-readable medium having a plurality of program modules 168 thereon that, when read by the processor 162, cause the processor to execute certain operations. Among the operations are operation of an inspection method 200, as will be described. For example the plurality of program modules 168 may include instructions that cause the processor 162 to (a) receive backpressure of a fluid traversing one of a first flow aperture and a second flow aperture defined in a workpiece supported at a seat of an inspection fixture using a backpressure sensor coupled to the seat of the inspection fixture, (b) determine fluid conductance of one or more of the first flow aperture and the second flow aperture using the backpressure received from the backpressure sensor, (c) receive optical image data of a portion of the workpiece including one or more of the first flow aperture and the second flow aperture defined in the workpiece from an optical focal plane array coupled to the seat of the inspection fixture; and (d) determine flow area of one or more of the first flow aperture and the second flow aperture using the optical image data received from the optical focal plane array, the memory 166 being a computer program product 170 of an inspection system 172 in this respect.

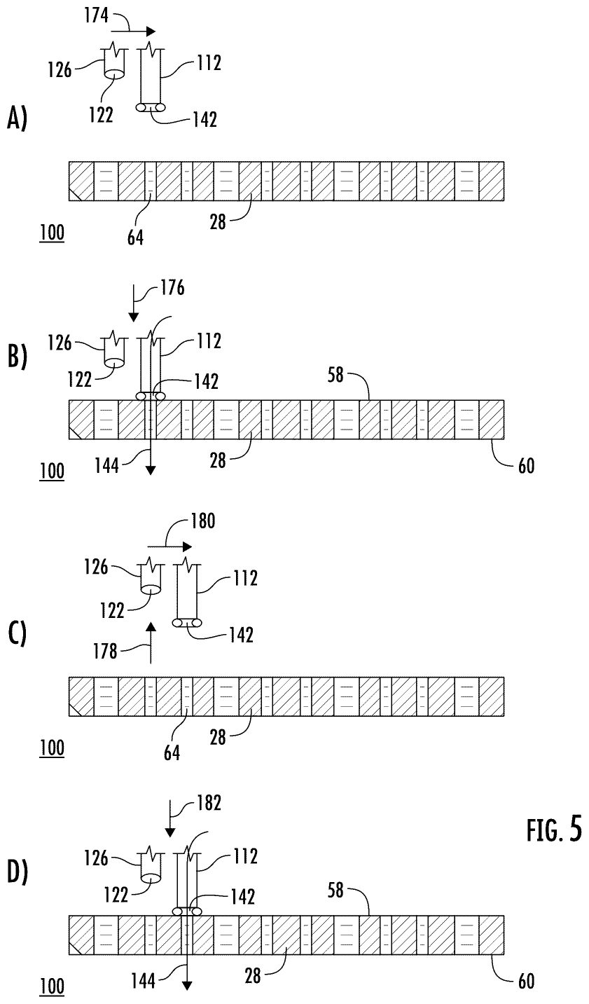

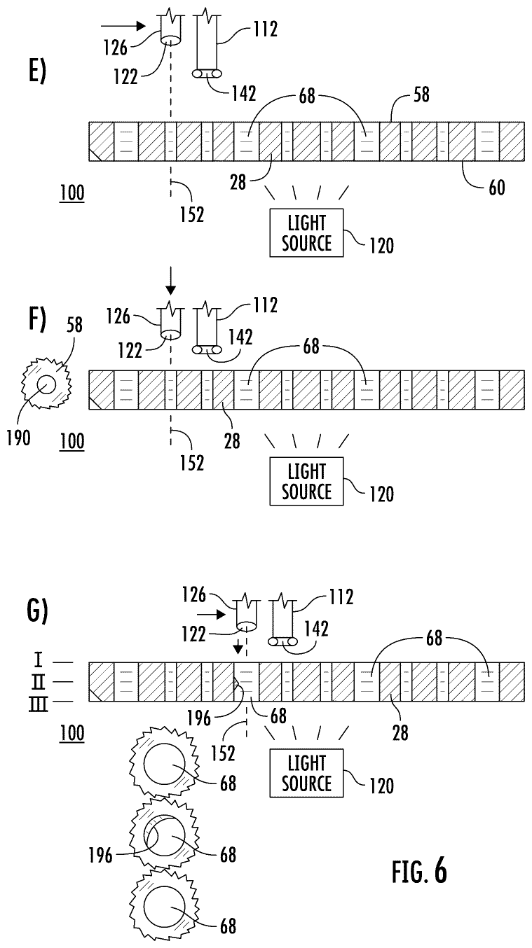

With reference to FIGS. 5 and 6, the workpiece 28 is shown undergoing fluid conductance inspection and flow are inspection while supported at the seat 102 (shown in FIG. 4) of the inspection fixture 100 in accordance with an example of the present disclosure. As shown at A in FIG. 5, fluid conductance inspection of the workpiece 28 may be performed by registering the outlet 142 of the fluid conduit 112 to one of the plurality of first flow apertures 64 defined in the workpiece 28, as shown with arrow 174. Registration the outlet 142 to the one of the plurality of first flow apertures 64 may be accomplished by driving the crossbeam 104 (shown in FIG. 4) using the registration drive 108 (shown in FIG. 4), for example according to coordinates of a location of interest determined by the controller 134 (shown in FIG. 4). As shown at B in FIG. 5, the outlet 142 of the fluid conduit 112 may then be driven into abutment with the first surface 58 of the workpiece 28 and sealably about the one of the plurality of first flow apertures 64, as shown with arrow 176. Abutment may be accomplished by driving the probe member 106 (shown in FIG. 4) using the abutment/focus drive 110 (shown in FIG. 4), for example again using the controller 134, such that a resilient member extending about the outlet 142 compresses between the fluid conduit 112 and the first surface 58 of the workpiece. The fluid 144 may thereafter be communicated to the first flow aperture 38 from the fluid source 114 (shown in FIG. 4) through the fluid conduit 112, and backpressure acquired using the backpressure sensor 116 (shown in FIG. 4) from the fluid 144 flowing through the fluid conduit 112 as the fluid 144 issues from the one or the plurality of the first flow apertures 64 defined in the workpiece 28 at the second surface 60 of the workpiece 28.

Once the backpressure is acquired, for example based on stability of the backpressure signal 148 (shown in FIG. 4), the fluid conduit 112 may be withdrawn from the first surface 58 of the workpiece 28, again using the registration drive 108 (shown in FIG. 4), as shown at C in FIG. 5 with arrow 178. The fluid conduit 112 may then be registered to another of the plurality of first flow apertures 64 using the registration drive 108, as shown at C in FIG. 5 with arrow 180, and the fluid conduit 112 driven once again into abutment with the first surface 58 of the workpiece 28 sealably about another of the plurality of first flow apertures 64 using the abutment/focus drive 110, as shown at D in FIG. 5 with arrow 182. The fluid 144 may thereafter be communicated to the another of the plurality of first flow apertures 64 using the fluid source 114, and backpressure of the another of the plurality of first flow apertures 64 acquired using the backpressure sensor 116, and shown in FIG. 5 at C and D. In certain examples of the present disclosure backpressure may be acquired for each of the plurality of the first flow apertures 64 defined in the workpieces 28 by communicating the fluid 144 sequentially to each of the plurality of first flow apertures 64. In accordance with certain examples of the present disclosure, only a subset of the plurality of first flow apertures 64 may undergo fluid conductance inspection, a subset of the plurality of first flow apertures 64 undergoing fluid conductance inspection using radiographic image data 184 acquired of the workpiece 28 (shown in FIG. 1). Advantageously, selecting a subset of the plurality of first flow apertures 64 for flow conductance inspection using radiographic image data may limit time required for inspection of the workpiece 28.

In certain examples the backpressure sensor 116 may be calibrated prior to inspecting flow area of the one of the first flow aperture 38 and second flow aperture 40. In this respect it is contemplated that the outlet 142 of the fluid conduit 112 may be registered to the one more calibration flow aperture 119 of the calibration block 118, driven into abutment with the calibration block 118, and the calibration fluid 144 flowed through the one or more calibration flow aperture 119 such that a backpressure acquired by the backpressure sensor 116 can compared to a predetermined backpressure sensor calibration value to assess health of the inspection fixture 100. Backpressure sensor calibration may be performed prior to seating the workpiece 28 on the seat 102. Backpressure sensor calibration may be performed while the workpiece 28 is seated on the seat 102 and prior to inspecting fluid conductance through the one of the first flow aperture 38 and the second flow aperture 40. Backpressure sensor calibration may be performed between inspecting fluid conductance of individual ones of the plurality of first flow apertures 64 defined in the workpiece 28, such as responsive to acquisition of an aberrant backpressure measurement from one of the plurality of first flow apertures 64. And backpressure sensor calibration may be performed subsequent to inspecting fluid conductance of the workpiece 28, for example to assess the inspection fixture 100 for drift during inspection of the workpiece 28.

As shown at E in FIG. 6, flow area inspection of the workpiece 28 may be performed by registering the one or more optical element 122 to one of the plurality of first flow apertures 64 defined in the workpiece 28, as shown with arrow 186. Registration may again be accomplished by driving the crossbeam 104 (shown in FIG. 4) using the registration drive 108 (shown in FIG. 4), for example according to coordinates of a location of interest determined by the controller 134 (shown in FIG. 4) based on flow conductance inspection of the one of the plurality of first flow apertures 64. As shown at F in FIG. 6, the one or more optical element 122 may then be driven along an optical axis 152 optically coupling the one or more optical element 122 to the workpiece 28 such that flow area 188 of the one or more of the first flow apertures 64 comes into focus at a specific location with the thickness 62 of the workpiece 28, as shown with arrow 190. In this respect it is contemplated that the one or optical element 122 may be driven by the abutment/focus drive 110 such that the flow area 188 presented to the optical focal plane array 124 is indicative of flow area of the one of the plurality of first flow apertures 64 at the first surface 58, the second surface 60, or at a location within the thickness intermediate the first surface 58 and the second surface 60. As above, focusing one or more optical element 122 may be accomplished by driving the probe member 106 (shown in FIG. 4) using the abutment/focus drive 110 (shown in FIG. 4), such as through the controller 134, focusing enabled (at least in part) in some examples by an axial offset between the one or more optical element 122 and the outlet 142 of the fluid conduit 112. The optical image data 158 (shown in FIG. 4) may then be acquired using light collected by the one or more optical element 122 and conveyed to the optical focal plane array 124 (shown in FIG. 4) by the optical waveguide 126.

Once the optical image data 158 of the one of the plurality of first flow apertures 64 is acquired, additional optical image data may be acquired of another of the plurality of first flow apertures 64 and the plurality of second flow aperture 68 defined in the workpiece 28. In this respect it is contemplated that the one or more optical element 122 may be registered to another of the plurality of first flow apertures 64, such as based on backpressure acquired of the another of the plurality of first flow apertures 64 during fluid conductance inspection of the workpiece 28. In further respect, it is also contemplated that flow area of one or more of the plurality of second flow apertures 68 may be inspected. In this respect, as shown at G in FIG. 6 with arrow 192, the one or more optical element 122 may be registered to one of the plurality of second flow apertures 68, for example again using the registration drive 108 (shown in FIG. 4). As shown at G in FIG. 6 with arrow 194, the one or more optical element 122 may then again be driven along the optical axis 152, and additional optical image data 158 (shown in FIG. 4) of the workpiece 28 including the one of the plurality of second flow apertures 68 acquired using the optical focal plane array 124 (shown in FIG. 4). As will be appreciated by those of skill in the art in view of the present disclosure, optical inspection of flow area, though typically relatively slow in relation to fluid conductance inspection, is generally more accurate than fluid conductance inspection in terms of determining whether rework (e.g., by redrilling or recleaning) of a flow aperture exhibiting a backpressure anomalies is warranted.

In certain examples, a plurality of optical image data sets may be acquired of a singular one of the plurality of second flow apertures 68. In this respect the one or more optical element 122 may be driven along the optical axis 152 to first offset distance from the workpiece 28 and an optical image data set I of the one of the plurality of second flow apertures 68 acquired, for example to acquire flow area of the one of the plurality of second flow apertures 68 at a location proximate the first surface 58 of the workpiece 28. The one or more optical element 122 may then be driven along the optical axis 152 to a second offset distance from the workpiece 28, and an optical image data set II of the one of the plurality of second flow apertures 68 acquired, for example to acquire flow area of the one of the plurality of second flow apertures 68 at a location therein intermediate the first surface 58 and the second surface 60 of the workpiece 28. The one or more optical element 122 may thereafter be driven along the optical axis 152 to a third offset distance from the workpiece 28 and an optical image data set III of the one of the plurality of second flow apertures 68 acquired, for example to acquire flow area of the one of the plurality of second flow apertures 68 at a location therein proximate the second surface 60 of the workpiece 28. Advantageously, acquiring a plurality of optical image data sets enables identifying depth of occlusions within flow apertures defined within the workpiece 28, such as accretions 196 formed during communication of the process fluid 18 (shown in FIG. 1) within the fluid system 10 and resistant to the technique employed to clean the workpiece 28, limiting (or eliminating) risk that such accretions remain in the workpiece 28 upon installation in a fluid system, e.g., the fluid system 10, following cleaning.

In certain examples of the present disclosure, flow area of each of the plurality of second flow apertures 68 may be individually inspected by acquiring optical image data of each of the plurality of second flow apertures 68. In accordance with certain examples of the disclosure, flow area of only a subset of the plurality of second flow apertures 68 may be individually inspected by acquiring optical image data of each of the subset of the plurality of second flow apertures 68, for example using the radiographic image data 184 (shown in FIG. 1) of the workpiece 28 to identify the subset of the plurality of second flow apertures 68 requiring flow area inspection. It is further contemplated that flow area may be inspected by illuminating an underside of the workpiece 28 using visible light emitted by the light source 120. Advantageously, fluid conductance inspection and flow area inspection of the plurality of first flow apertures 64, in conjunction with flow area inspection of the plurality of second flow apertures 68 (either in totality or in subset), may limit time required for inspection of workpieces having flow apertures of difference sizes, such as in examples where the size and pitch of relatively small flow apertures requires use of fluid conduit 112 too small to effectively inspect fluid conductance relatively large flow apertures in a singular flow aperture fluid conductance inspection regime.

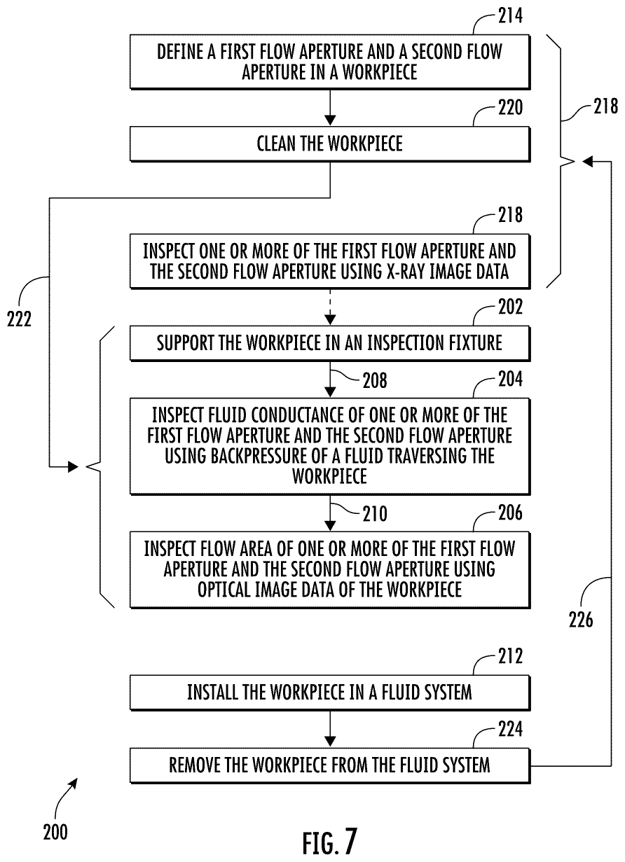

With reference to FIGS. 7-10, the inspection method 200 is shown according to an illustrative and non-limiting example of the present disclosure. As shown in FIG. 7, the inspection method 200 generally includes supporting a workpiece on an inspection fixture, e.g., supporting the workpiece 28 (shown in FIG. 1) in the inspection fixture 100 (shown in FIG. 1), as shown with box 202; inspecting fluid conductance of one or more of a first flow aperture and a second flow aperture defined in the workpiece using backpressure of a fluid traversing one or more of the first flow aperture and the second flow aperture, e.g., backpressure of the fluid 144 (shown in FIG. 4) during traverse of the first flow aperture 38 (shown in FIG. 2) and the second flow aperture 40 (shown in FIG. 2), as shown with box 204; and flow area of one or more of the first flow aperture and the second flow aperture using optical image data of a portion of the workpiece including one or more of the first flow aperture and the second flow aperture acquired using a focal plane array, e.g., the optical image data 158 (shown in FIG. 4) acquired using the optical focal plane array 124 (shown in FIG. 4), as shown with box 206. It is contemplated that inspecting 204 fluid conductance of the workpiece and inspecting 206 flow area of the workpiece be performed subsequent to seating the workpiece on the inspection fixture, as shown with arrow 208. It is also contemplated that inspecting 206 flow area of the at least one of the first flow aperture and the second flow aperture may be performed subsequent to inspection 204 fluid conductance of one or more of the first flow aperture and the second flow aperture, as shown with arrow 210. It is further contemplated that the workpiece may be installed in a fluid system, e.g., the fluid system 10 (shown in FIG. 1), subsequent to inspecting 204 fluid conductance of one or more of the first flow aperture and the second flow aperture and/or inspecting 206 flow area of the one or more of the first flow aperture and the second flow aperture, as shown with box 212.

In certain examples of the present disclosure, inspecting 204 fluid conductance may be performed subsequent to forming the workpiece, for example by defining one or more of the first flow aperture and the second flow aperture in the workpiece using a subtractive or additive manufacturing technique, as shown with box 214. In such examples the workpiece may be inspected radiographically subsequent to forming 212 the workpiece, such as by supporting the workpiece between an x-ray source and an x-ray detector and acquiring radiographic image data of the workpiece include at least a portion of the workpiece including the first flow aperture and the second flow aperture, as shown with bracket 216 and box 218. In accordance with certain examples of the disclosure the workpiece may be cleaned prior to inspecting 204 fluid conductance of one or more of the first flow aperture and the second flow aperture and/or inspecting 206 flow area of the one or more of the first flow aperture and the second flow aperture, as shown with box 220 and arrow 222. In such examples the workpiece may be radiographically inspected subsequent to cleaning, as also shown with bracket 218. It is also contemplated that the radiographic inspection may not be conducted prior to inspecting 204 fluid conductance of one or more of the first flow aperture and the second flow aperture and/or inspecting 206 flow area of the one or more of the first flow aperture and the second flow aperture, such as when the workpiece is removed from a fluid system for cleaning, as shown with box 224 and arrow 226, and remain within the scope of the present disclosure.

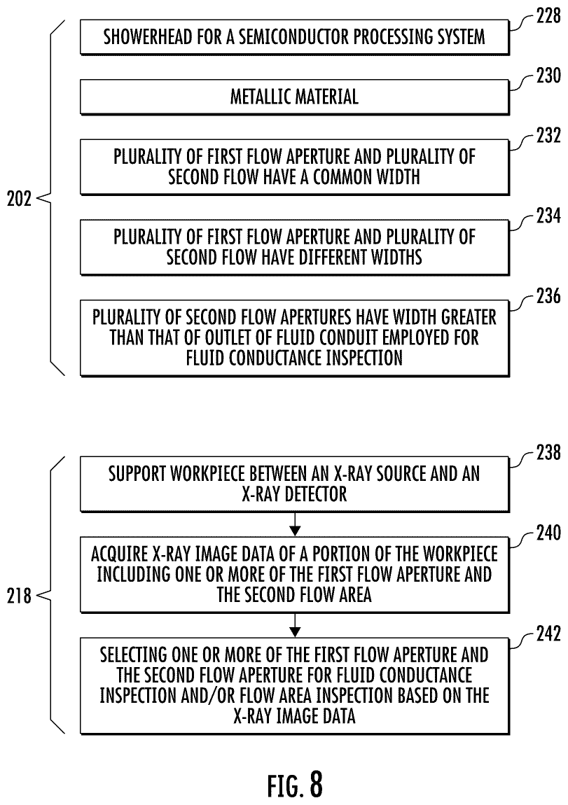

As shown in FIG. 8, supporting 202 the workpiece on the inspection fixture may include supporting a showerhead for semiconductor processing system on a seat of the inspection fixture, e.g., the seat 102 (shown in FIG. 4) of the inspection fixture 100 (shown in FIG. 1), as shown with box 228. Supporting the workpiece on the inspection fixture may include supporting a workpiece formed from a metallic material on the inspection fixture, as shown with box 230. Supporting 202 the workpiece on the inspection fixture may include seating a workpiece on the seat where the first flow aperture and the second flow aperture have a common width, as shown with box 232. Supporting 202 the workpiece on the inspection fixture may include supporting a workpiece wherein the first flow aperture is one of a plurality of first flow apertures having a first width, the second flow aperture is one of a plurality of second flow apertures having a second width, and that that the second width is greater than the first width, as shown with box 234. In certain examples, the second width may be greater than a width of the outlet of the flow conduit employed for flow conductance inspection, as shown with box 236. In accordance with certain examples, the workpiece may define therein a large number of the flow apertures, for example, between 50 and 2000 flow apertures, or between 500 and 2000 flow apertures, or even between 1000 and 2000 flow apertures. As will be appreciated by those of skill in the art in view of the present disclosure, since flow conductance inspection may require less time than optical inspection of flow area, selective optical inspection of flow area, such as only in the event of detection of an anomaly through radiographic inspection and/or flow conductance inspection through backpressure measurement, may limit time required to inspect the workpiece.

Inspecting 218 the workpiece radiographically may include supporting the workpiece between an x-ray source and x-ray source, as shown with box 238. Inspecting 218 the workpiece radiographically may further include acquiring x-ray image data of a portion of the workpiece including one or more of the first flow aperture and the second flow aperture, as shown with box 240. Inspecting 218 the workpiece radiographically may include selecting one or more of the plurality of first flow apertures and the plurality of second flow apertures for inspection, for example for fluid conductance inspection and/or flow area inspection, as shown with box 242. As will be appreciated, inspecting flow apertures using fluid conductance and/or flow area techniques on the basis of a prior radiographic inspection may reduce the number of flow apertures requiring fluid conductance inspection and/or flow area inspection, reducing time otherwise required to inspect the workpiece using the inspection fixture.

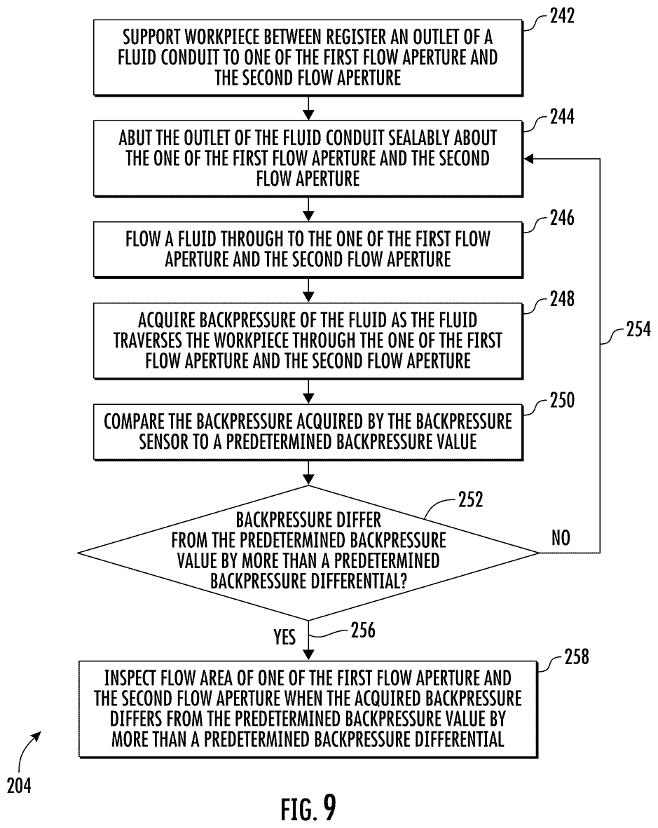

Referring to FIG. 9, inspecting 204 fluid conductance of one or more of the first flow aperture and the second flow aperture may include registering an outlet of a fluid conduit, e.g., the outlet 142 (shown in FIG. 4) of the fluid conduit 112 (shown in FIG. 4), to one of the first fluid conduit and the second fluid conduit, as shown with box 242. Inspecting 204 fluid conductance of one or more of the first flow aperture and the second flow aperture may include registering and thereafter abutting the outlet against the workpiece, for example such that outlet extends sealably about the one of the first flow aperture and the second flow aperture, as shown with box 244. Inspecting 204 fluid conductance of one or more of the first flow aperture and the second flow aperture may include flowing a fluid from a fluid source, e.g., the fluid 144 (shown in FIG. 4) from the fluid source 114 (shown in FIG. 4), through the fluid conduit and into one of the first flow aperture and the second flow aperture such that fluid entering the first surface of the workpiece issues from the second surface of the workpiece via the one of the first flow aperture and the second flow aperture, as shown with box 246. Backpressure of the fluid may be acquired as the fluid flows through the one of the first flow aperture and the second flow aperture, e.g., using the backpressure signal 148 (shown in FIG. 4) provided by the backpressure sensor 116 (shown in FIG. 4) of the inspection fixture, as shown with box 248.

It is contemplated that the backpressure be compared to a predetermined backpressure value, as shown with box 250 and box 252. Additional flow apertures of the plurality of first flow apertures may undergo fluid conductance inspection, flow apertures of the second plurality of flow apertures undergo optical inspection, or the workpiece may be installed within a fluid system when the backpressure differs from the predetermined backpressure value by less than a predetermined backpressure differential, as shown with box 252 and arrow 254. Flow area of the one of the first flow aperture and the second flow aperture may be inspected by acquiring optical image data of a portion of the workpiece and the one of the first flow aperture and the second flow aperture when the backpressure differs from the predetermined backpressure value by more than the predetermined backpressure differential, as shown with arrow 256 and box 258. Comparison of the acquired backpressure to the predetermined backpressure value may be accomplished by communicating the backpressure value to a processor, e.g., the processor 162 (shown in FIG. 4), as also shown with box 244. Determination as to whether the backpressure differs from the predetermined backpressure differential may also be accomplished using the processor, as further shown with box 244. It is contemplated that fluid conductance inspection and flow area inspection may be accomplished at a singular fixture, as also shown with box 206.

In certain examples, only a subset of flow aperture defined in the workpiece may undergo fluid conductance. For example, fluid conductance of the one of the first flow aperture and the second flow aperture may be inspected based x-ray image data acquired of the workpiece. Fluid conductance of the one of the first flow aperture and the second flow aperture may be inspected based on size of the one of the first flow aperture and the second flow aperture, for example when the first flow aperture is one of a plurality of first flow apertures having a first width less than a width of the outlet of the conduit and the second flow aperture is one of a plurality of second flow apertures having second widths greater than the width of the outlet. It is also contemplated that all of the plurality of first flow apertures and/or all of the plurality of second flow apertures may undergo fluid conductance inspection and remain within the scope of the present disclosure.

In certain examples of the present disclosure, inspecting 204 flow conductance of one or more of the first flow aperture and the second flow aperture may include calibrating the backpressure sensor, as shown with reference arrow 204. In this respect the outlet of the fluid conduit may be registered to a calibration flow aperture defined in a calibration block, e.g., the one or more calibration flow aperture 119 (shown in FIG. 4) defined within the calibration block 118 (shown in FIG. 4), as also shown with reference arrow 204. The outlet of the fluid conduit may be driven into abutment with a first surface of the calibration block and sealably about the one or more flow aperture, for example a singular one of the one or more calibration flow apertures, and the calibration fluid communicated through the calibration block such that the calibration fluid issues from a second surface of the calibration block opposite the first surface, further shown with reference arrow 204. Backpressure measurements may acquired as the fluid issues from the calibration block, compared to a predetermined calibration backpressure value recorded in one of the plurality of program modules recorded on a memory, and a user output provided to a user interface indicating that the inspection fixture is performing reliably when the acquired backpressure differs from the predetermined calibration backpressure value by less than a predetermined backpressure calibration differential, and a user output provided to the user interface indicating the inspection fixture is not performing reliably when the acquired backpressure differs from the predetermined backpressure calibration value by more than the predetermined backpressure differential value, as further shown with reference arrow 204. It is contemplated that calibration may be performed prior to inspecting backpressure of the workpiece and/or subsequent to inspecting backpressure of the workpiece. It is also contemplated that calibration may be accomplished responsive to a backpressure of one or more flow aperture defined in the workpiece differing from the aforementioned predetermined backpressure value by more than the aforementioned backpressure differential, as also shown with box 252. As will be appreciated by those of skill in the art in view of the present disclosure, in-situ calibration of the inspection fixture may improve reliability of the inspection fixture.

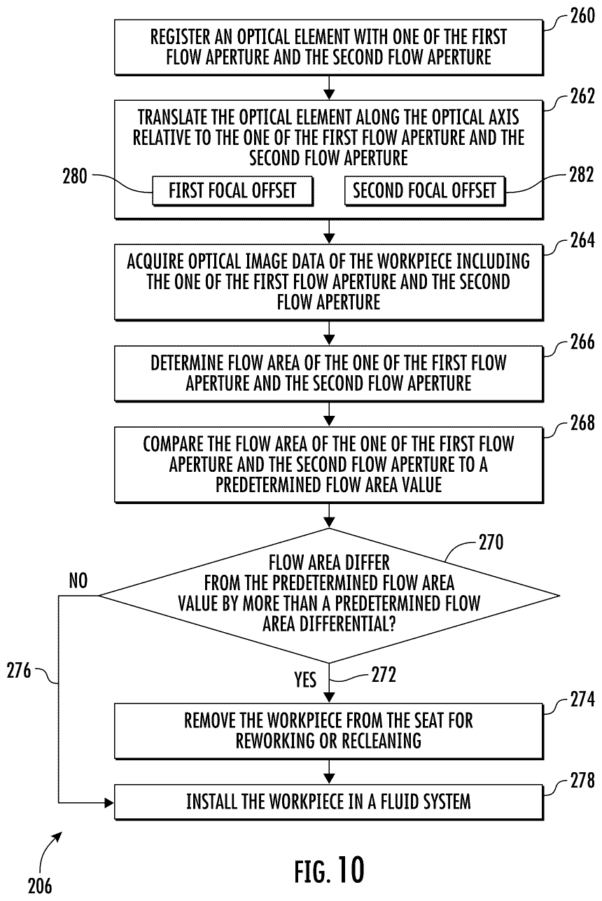

As shown in FIG. 10, inspecting 206 flow area of one or more of the first flow aperture and the second flow aperture may include registering an optical element arranged along an optical axis with the one of the first flow aperture and the second flow aperture, e.g., the optical element 122 (shown in FIG. 4) arranged along the optical axis 152 (shown in FIG. 4), as shown with box 260. Inspecting 206 of the flow area of the one the first flow aperture and the second flow aperture may include translating the optical element along the optical axis, such as to a predetermined focal distance from the workpiece, as shown with box 262. Inspecting 206 the one of the first flow aperture and the second flow aperture may include acquiring optical image data of the workpiece including the one of the first flow aperture and the second flow aperture, as shown with box 264. It is contemplated that a flow area of the one of the first flow aperture and second flow aperture be determined using the optical image data, as shown with box 266, and that the determined flow area of the one of the first flow aperture and the second flow aperture be compared to a predetermined flow area, as shown with box 268 and box 270.

When the determined flow area differs from the predetermined flow area by more than the predetermined flow area differential the one of the first flow aperture and the second flow aperture may be reworked, as shown with arrow 272 and box 274. In this respect the workpiece may be reworked, for example using a material removal operation similar to that used to form the one of the first flow aperture and the second flow aperture, as also shown with arrow 276 and box 278. In further respect, the workpiece (or the one of the first flow aperture and the second flow aperture) may be recleaned, for example using a cleaning process similar to that used to initially clean the workpiece and/or the one of the first flow aperture and the second flow aperture, as further shown with arrow 272 and box 274. It is contemplated that the workpiece may be installed in the fluid system when the determined flow area differs from the predetermined flow area by less than the predetermined flow area differential, as shown with arrow 276 and box 278. In certain examples of the present disclosure flow apertures may undergo optical inspection only when flow conductance inspection indicates that backpressure flow through the flow aperture is anomalous, for example when the aforementioned backpressure differs from the predetermined backpressure value by more than the predetermined backpressure differential. As will be appreciated by those of skill in the art in view of the present disclosure, this can limit time required for inspection the workpiece, for example in workpieces having large numbers of the flow apertures where inspection of each flow aperture would limit throughput of the inspection fixture. As will also be appreciated by those of skill in the art in view of the present disclosure, flow apertures not undergoing flow conductance inspection (e.g., due to size) may undergo flow area inspection using the aforementioned optical inspection operations.

In certain examples of the present disclosure flow area at the one of the first flow aperture and the second flow aperture may be determined at two or more locations between the first surface and the second surface of the workpiece, as also shown with box 262. In this respect first optical image data set may be acquired with the optical element at a first focal distance from the workpiece and one or more second optical image data set may be acquired with the optical element at one or more second focal distance from the workpiece, as shown with box 280 and 282. It is contemplated that a first flow area of the one of the first flow aperture and the second flow aperture be determined at first focal offset using the first image data, that one or more second flow area of the one of the first flow aperture and the second flow aperture be determined using the one or more second image data set, and that the first flow area and the one or more second flow area be compared to the predetermined flow area to determine whether either (or any) of the determined flow areas of the one of the first flow aperture or the second flow aperture differ from the predetermined flow area by more than the predetermined flow area differential, as also shown with boxes 260-282. As will be appreciated by those of skill in the art in view of the present disclosure, inspecting flow area along the length using an optical technique enables determining effective flow area of one or more of the first flow aperture and the second flow aperture, limiting (or eliminating) likelihood that chip or cuttings (as may be the case of new-build workpieces) or residual process fluid accretions (as may be the case of workpieces being cleaned) go undetected during inspection of the workpiece.

Although this disclosure has been provided in the context of certain embodiments and examples, it will be understood by those skilled in the art that the disclosure extends beyond the specifically described embodiments to other alternative embodiments and/or uses of the embodiments and obvious modifications and equivalents thereof. In addition, while several variations of the embodiments of the disclosure have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure should not be limited by the particular embodiments described above.

The headings provided herein, if any, are for convenience only and do not necessarily affect the scope or meaning of the devices and methods disclosed herein.

1. An inspection fixture, comprising:
a seat configured to support a workpiece;
a backpressure sensor coupled to the seat and configured to acquire backpressure of a fluid traversing one of a first flow aperture and a second flow aperture defined in the workpiece supported on the seat of the inspection fixture; and
an optical focal plane array coupled to the seat and configured to acquire optical image data of a portion of the workpiece including one or more of the first flow aperture and the second flow aperture defined in the workpiece supported on the seat of the inspection fixture.

2. The fixture of claim 1, further comprising a fluid conduit with an outlet supported for movement relative to the seat, wherein the backpressure sensor is arranged along the fluid conduit.

3. The fixture of claim 2, further comprising a fluid source connected to the fluid conduit and therethrough to the backpressure sensor, wherein the fluid source is configured to communicate the fluid to one or more of the first flow aperture and the second flow aperture through the backpressure sensor using the fluid conduit.

4. The fixture of claim 1, further comprising:
a light source fixed relative to the seat; and
a calibration block fixed relative seat and offset from the light source, the calibration block having one or more calibration flow aperture extending therethrough.

5. The fixture of claim 1, further comprising an optical element supported for movement relative to the seat, wherein the optical element is optically coupled to the optical focal plane array along an optical axis.

6. The fixture of claim 5, wherein the optical element comprises one or more of a lens, a mirror, and a grating.

7. The fixture of claim 5, further comprising a fluid conduit with an outlet supported for movement relative to the seat, wherein the outlet is fixed relative to the optical element.

8. The fixture of claim 1, further comprising a workpiece supported on the seat and having a first surface separated from a second surface by a thickness, the first surface coupled to the second surface by the first flow aperture, the first surface further coupled to the second surface by the second flow aperture.

9. The fixture of claim 8, wherein the first flow aperture is one of a plurality of first flow apertures having a first width, wherein the second flow aperture is one of a plurality of second flow apertures having a second width, the second width greater than the first width.

10. The fixture of claim 8, wherein a chip, a cutting, or an accretion from a process fluid communicated by the workpiece through the first flow aperture and/or the second flow aperture occludes one or more of the first flow aperture and the second flow aperture defined in the workpiece.

11. The fixture of claim 8, wherein the workpiece comprises a showerhead configured to distribute a process fluid within a process volume defined in a semiconductor processing system.

12. The fixture of claim 1, further comprising:
a crossbeam supported for movement relative to the seat;
a probe member carried by the crossbeam and supported for movement relative to the crossbeam;
a fluid conduit with an outlet fixed relative to the probe member; and
an optical element fixed relative to the probe member.

13. An inspection system, comprising:
an inspection fixture as recited in claim 1; and
a processor disposed in communication with the backpressure sensor and the optical focal plane array, the processor responsive to instructions recorded on a memory to:
receive backpressure of a fluid traversing one of a first flow aperture and a second flow aperture defined in the workpiece supported on the seat from the backpressure sensor;
determine fluid conductance of one or more of the first flow aperture and the second flow aperture using the backpressure received from the backpressure sensor;
receive optical image data of a portion of the workpiece including one or more of the first flow aperture and the second flow aperture defined in the workpiece supported on the seat from the optical focal plane array; and
determine flow area of one or more of the first flow aperture and the second flow aperture using the optical image data received from the optical focal plane array.

14. An inspection method, comprising:
supporting a workpiece at a seat of an inspection fixture;
acquire backpressure of a fluid traversing one of a first flow aperture and a second flow aperture defined in the workpiece using a backpressure sensor coupled to the seat of the inspection fixture;
determine fluid conductance of one or more of the first flow aperture and the second flow aperture using the backpressure received from the backpressure sensor;
acquire optical image data of a portion of the workpiece including one or more of the first flow aperture and the second flow aperture defined in the workpiece from an optical focal plane array coupled to the seat of the inspection fixture; and
determine flow area of one or more of the first flow aperture and the second flow aperture using the optical image data received from the optical focal plane array.

15. The method of claim 14, wherein determining fluid conductance comprises:
registering an outlet of a fluid conduit in fluid communication with the backpressure sensor to one of the first flow aperture and the second flow aperture defined in the workpiece seated on the seat of the inspection fixture;
abutting the outlet of the fluid conduit sealably about the one of the first flow aperture and the second flow aperture;
flowing a fluid through from a fluid source through the backpressure sensor and the fluid conduit to the one of the first flow aperture and the second flow aperture;
acquiring backpressure of the fluid from the backpressure sensor as the fluid traverses the workpiece through the one of the first flow aperture and the second flow aperture;
comparing the backpressure acquired by the backpressure sensor to a predetermined backpressure value; and
inspecting flow area of one of the first flow aperture and the second flow aperture when the acquired backpressure differs from the predetermined backpressure value by more than a predetermined backpressure differential.

16. The method of claim 15, wherein determining flow area comprises:
registering an optical element arranged along an optical axis with one of the first flow aperture and the second flow aperture seated on the seat of the inspection fixture;
translating the optical element along the optical axis relative to the one of the first flow aperture and the second flow aperture to optically couple the optical focal plane array;
acquiring optical image data of the workpiece including the one of the first flow aperture and the second flow aperture using the optical focal plane array;
determining flow area of the one of the first flow aperture and the second flow aperture using the acquired optical image data;
comparing the determined flow area of the one of the first flow aperture and the second flow aperture to a predetermined flow area value; and
removing the workpiece from the seat for rework when the determined flow area of the one of the first flow aperture and the second flow aperture differs from a predetermined flow area value by more than a predetermined flow area differential.

17. The method of claim 15, wherein acquiring backpressure comprises acquiring backpressure of only the first flow aperture defined in the workpiece.

18. The method of claim 17, wherein acquiring optical image data comprises acquiring optical image data of both the first flow aperture and the second flow aperture.

19. The method of claim 15, further comprising acquiring radiographic image data of the workpiece, wherein the backpressure and the optical image data are acquired using the radiographic image data of the workpiece.

20. The method of claim 14, further comprising calibrating the backpressure sensor prior to inspecting backpressure and subsequent to inspecting backpressure of the workpiece.

21. A computer program product, comprising:
a non-transitory machine readable medium having instructions recorded on the medium that, when read by a processor, cause the processing to:
receive backpressure of a fluid traversing one of a first flow aperture and a second flow aperture defined in a workpiece supported at a seat of an inspection fixture using a backpressure sensor coupled to the seat of the inspection fixture;
determine fluid conductance of one or more of the first flow aperture and the second flow aperture using the backpressure received from the backpressure sensor;
receive optical image data of a portion of the workpiece including one or more of the first flow aperture and the second flow aperture defined in the workpiece from an optical focal plane array coupled to the seat of the inspection fixture; and
determine flow area of one or more of the first flow aperture and the second flow aperture using the optical image data received from the optical focal plane array.
